(19) United States
(12) Patent Application Publication
(10) Pub. No.: US 2007/0121884 A1
(43) Pub. Date: May 31, 2007

(54) MULTIPLE DID NUMBER SUPPORT FOR A VOIP SYSTEM

(76) Inventors: Sam K. SIN, San Jose, CA (US); Jan FANDRIANTO, Los Gatos, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/466,929

(22) Filed: Aug. 24, 2006

Related U.S. Application Data
(60) Provisional application No. 60/737,930, filed on Nov. 18, 2005.

(51) Int. Cl. H04M 7/00

(52) U.S. Cl. 379/219

(57) ABSTRACT

In one embodiment, a method includes receiving, at an IP PBX, a SIP INVITE request comprising a Request-URI field identifying a URI of the IP PBX and a header field identifying a target DID number. The method also includes identifying a URI corresponding to the target DID number and forwarding the SIP INVITE request with a Request-URI field identifying the URI corresponding to the target DID number.

### RELATED APPLICATION

This application claims the benefit of priority from U.S. provisional patent application Ser. No. 60/737,930, filed on Nov. 18, 2005, entitled “Supporting Multiple DID Numbers with a Single ITSP Registration by Embedding DID Information into SIP INVITE Messages,” the disclosure of which is incorporated herein in its entirety.

### BACKGROUND

A company wishing to provide telephone service to the members of the company may utilize a private branch exchange (PBX). Each telephone set that connects to and is served by the PBX is referred to as a client station or station. The use of a PBX may help to avoid the burden and cost of separately connecting each of the company's telephone sets to the public switched telephone network (PSTN). In addition, a PBX may provide additional advanced features which may not be achievable by connecting the stations directly to the PSTN. For example, the PBX may provide improved privacy when calling between stations, since conventional calls on the PSTN are transmitted across a public network, which is subject to eavesdropping. In addition, the PBX may provide additional services, such as call park, call pickup, call transfer, and call forward to other stations.

In order to provide individual users with their own telephone numbers, telephone service providers offer a feature known as Direct Inward Dialing (DID), in which the service provider allocates a range of numbers all associated with the company's PBX system. As calls are presented to the PBX system, the service provider also provides the DID number dialed by the caller, and the PBX system will route the call to the station associated with that DID number. For an IP PBX, each client station would register with an Internet Telephone Service Provider (ITSP) in order to establish a binding of the DID number to that particular client station. Each client station that is assigned a different DID number will be separately registered with the ITSP. As a result, there must be multiple registrations with the ITSP for a single IP PBX with multiple DID numbers. Each separate registration also implies a separate account to be provisioned by the ITSP, with a different User Identification (ID) and password. All of this increases the administrative burden and cost associated with providing multiple DID numbers.

### BRIEF DESCRIPTION OF THE DRAWINGS

FIG. 1 illustrates an example telecommunications system.

FIG. 2 illustrates an example architecture of an IP PBX.

FIG. 3 illustrates an example call flow.

### DESCRIPTION OF EXAMPLE EMBODIMENTS

In the following description, reference is made to the accompanying drawings which illustrate several embodiments of the present invention. It is understood that other embodiments may be utilized and mechanical, compositional, structural, electrical, and operational changes may be made without departing from the spirit and scope of the present disclosure. The following detailed description is not to be taken in a limiting sense, and the scope of the embodiments of the present invention is defined only by the claims of the issued patent.

Some portions of the detailed description which follows are presented in terms of procedures, steps, logic blocks, processing, and other symbolic representations of operations on data bits that can be performed on computer memory. Each step may be performed by hardware, software, firmware, or combinations thereof.

As used herein, the singular forms “a”, “an” and “the” are intended to include the plural forms as well, unless the context indicates otherwise. It will be further understood that the terms “comprises” and/or “comprising” specify the presence of stated features, steps, operations, elements, and/or components, but do not preclude the presence or addition of one or more other features, steps, operations, elements, components, and/or groups thereof.

As described above, in order to provide individual users with their own telephone numbers, conventional telephone service providers (SP) offer DID dialing, in which the SP allocates a range of numbers all associated with the company's PBX system. DID enables companies to have fewer trunk lines to the service provider than telephone extensions, while still providing a unique number for each extension. The use of DID is desirable because if a station is not assigned a DID number, then a caller on the PSTN side cannot call this station directly. The caller may need to a call a main number on the PBX, wait for the call to be answered by a live or an Automated Attendant (AA), then get transferred to the target station. On the other hand, if the station is assigned a DID number, then the PSTN caller can dial the DID number to ring the target station directly without going through another attendant. In order to provide DID numbers to its stations, a traditional PBX must recognize which DID is being called from the signaling information associated with the incoming PSTN call, and ring the corresponding station. In order for people connected to the PSTN network to call people connected to Voice Over Internet Protocol (VoIP) networks, DID numbers from the PSTN network are obtained by the administrators of the VoIP network, and assigned to a gateway in the VoIP network. The gateway will then route calls incoming from the PSTN across the IP network to the appropriate VoIP user.

Session Initiation Protocol (SIP) is an application-layer control protocol that can establish, modify, and terminate multimedia sessions such as Internet telephony calls. SIP is defined in RFC-3261, “SIP: Session Initiation Protocol,” which is incorporated by reference herein in its entirety. An IP PBX is a type of PBX that connects to client stations on the private side via an IP network, and connects to an Internet Telephone Service Provider (ITSP) on the public side via an IP network. The ITSP includes PSTN gateways, which provide PSTN termination services. Where SIP is used as the signaling protocol between the IP PBX and the ITSP, the logical connection between the IP PBX and the ITSP is referred to as a SIP trunk. The IP PBX may route SIP calls received from the ITSP to the target station in the IP PBX's SIP network. In order to provide DID functionality on an IP PBX, each client station would register with the ITSP in order to establish a binding of the DID number to that particular client station. The binding would include information such as the IP address and port number for the ITSP to contact the client station. When the ITSP intercepts a PSTN call to that DID number, the ITSP will search for the binding and route the call to the corresponding client station according to the contact information stored for that binding. Therefore, each client station that is assigned a different DID number will be separately registered with the ITSP, resulting in multiple registrations with the ITSP for a single IP PBX.

In particular embodiments, a single communications device may be configured to support multiple DID numbers using a single line interface. This can apply to a IP PBX that obtains PSTN termination services from an ITSP. The IP PBX may have the form factor of a typical VoIP ATA (Analog Telephone Adapter) and can serve one or more client stations (telephones, etc.). The IP PBX registers only a single address (e.g., the “main number”) with the ITSP. This registration establishes a binding of the main number to the IP PBX. The ITSP should have the knowledge of which DID numbers are tied to this main number. When one of the DID numbers is called from the PSTN and received by the ITSP, the ITSP routes the call to the IP PBX by sending it a SIP message (e.g., a SIP INVITE message). The DID number is embedded inside this SIP INVITE message (e.g. by specifying the DID number in the “TO” field of the SIP INVITE message header as an additional parameter). When the IP PBX receives this INVITE message, it extracts the embedded DID number from the message header, maps the DID number to one or more PBX stations that it is serving (using any suitable internal protocol), and routes the call to the corresponding stations accordingly. With this method, the ITSP only maintains one account to service the IP PBX, with a single User ID and password.

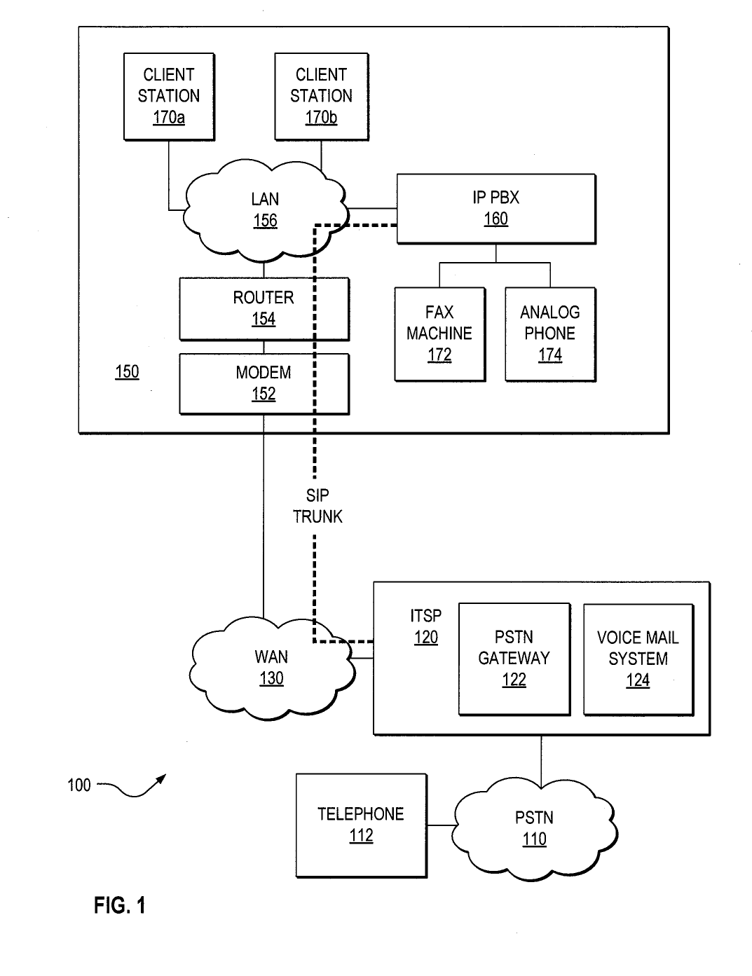

FIG. 1 illustrates an example telecommunications system 100 in particular embodiments. In this system 100, an ITSP 120 provides the connection between the PSTN 110 and a packet-based network, such as a WAN 130 (e.g., the Internet). The ITSP 120 provides a PSTN gateway 122 which terminates calls originating from telephones 112 on the PSTN 110 with target client stations on the WAN 130. The system 100 also includes a customer location 150, which includes a modem 152 that provides an interface to the WAN 130. A router 154 may provide multiple connections to a Local Area Network (LAN) 156. An IP PBX 160 is provided in the customer location 150 for routing SIP calls received from the ITSP 120.

It will be understood that the arrangement shown in FIG. 1 is merely exemplary and other variations are possible. For example, the IP PBX 160 may provide the routing and/or modem function in addition to providing the telecommunications functions as will be described in further detail below. The IP PBX 160 may also operate as an Analog Telephone Adapter (ATA) and includes two Foreign Exchange Station (FXS) ports for connection with an analog telephone 174, a fax machine 172, or a music source adapter. The IP PBX 160 may also contain components that operate as a SIP proxy server and media proxy server, as will be described in greater detail below. Finally, the IP PBX 160 may contain components that serve as a configuration server, which serves configuration files to client stations and auto-configures unprovisioned client stations, and as an application server for supporting advanced call features, such as call park/pickup, directory, directed call pickup, and group paging.

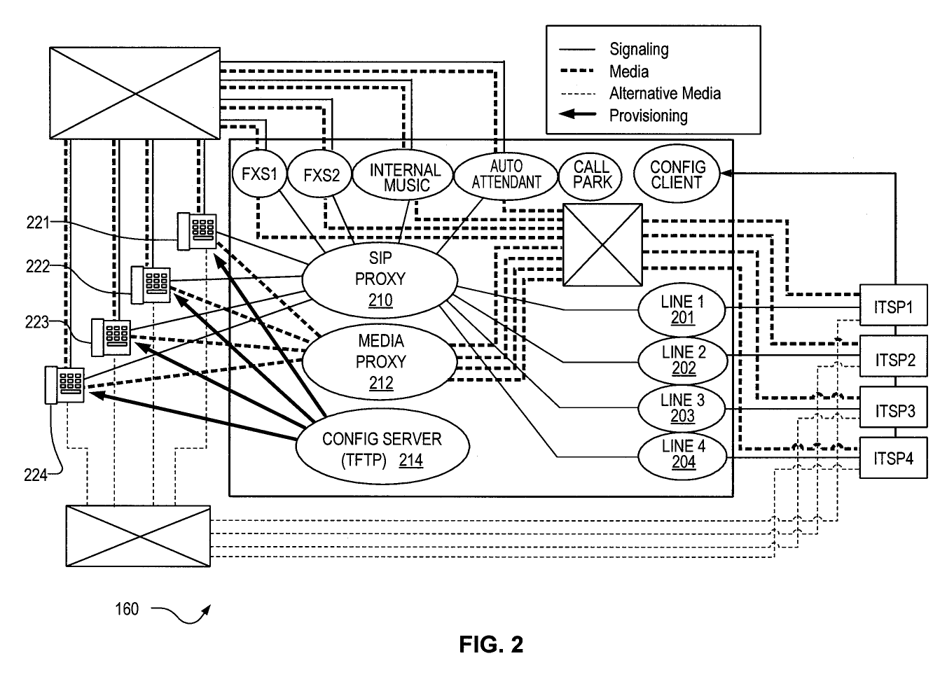

FIG. 2 illustrates an example architecture of an IP PBX 160 in particular embodiments. The IP PBX 160 includes one or more logical line interfaces (e.g., four line interfaces 201-204, as shown in FIG. 2). Each line interface 201-204 corresponds to an ITSP SIP account from which the IP PBX obtains PSTN termination services. Each SIP account is characterized by a User ID (unique within the ITSP domain), and optional password, and a package of features and resources associated with the account based on the service contract between the IP PBX operator and the ITSP. Each line interface 201-204 is logically connected with the ITSP office equipment to realize a SIP trunk. The resources associated with the account include a main number and/or a group of DID numbers that are allocated to this SIP trunk. Each line interface 201-204 can be configured with the same or a different ITSP, thereby providing connectability with as many different ITSPs as there are line interfaces (e.g., up to four different ITSPs, such as ITSP1-ITSP4, as shown in FIG. 2). An advantage of having a plurality of line interfaces is that a different ITSP may be used for different countries or regions. For example, when a station is used to call a PSTN number in Japan, the IP PBX may be configured to detect the country code dialed and automatically select the line interface associated with a Japanese ITSP.

The SIP proxy server component 210 in the IP PBX 160 accepts Registration from the client stations. The private side of the SIP proxy server component 210 serves the client stations (including external and internal clients) and the public side of the SIP proxy server component 210 interfaces with the ITSP.

In some embodiments, there are 5 internal clients that register implicitly with the SIP proxy server component 210: FSX1, FXS2, Internal Music (IMUSIC), Parking-Lot (PL), and Auto-Attendant (AA). The FSX1 and FXS2 clients correspond to the two physical FXS ports. The IMUSIC client, when called, automatically answers and plays internally stored audio to the caller. PL is used to maintain calls that are parked. AA is a scriptable auto-attendant application. The FSX1 and FXS2 clients can handle, e.g., up to 2 calls simultaneously. In other embodiments, such as when the FSX1 or FXS2 component of the IP PBX 160 is configured as a Streaming Audio Server (SAS), the FXS1 or FXS2 client may handle up to 10 simultaneous calls. The IMUSIC client can be used to support MOH even if no external audio source is connect to the IP PBX. The PL and AA can handle up to 10 calls simultaneously. A soft limit of less than 10 simultaneous calls may apply when multiple features are executing at the same time. These simultaneous call limits are merely exemplary and may vary, depending on the configuration and hardware of the IP PBX 160. Each line interface 201-204 may act as a Back-to-back User Agent (B2BUA). The B2BUA operates like a user agent towards both ends of a SIP call, and is responsible for handling all SIP signaling between both ends of the call, from call establishment to termination. In other embodiments, one or more of these internal client components may be omitted and/or provided as external clients.

The Media proxy server component 212 routes media between client stations and the ITSPs. In some embodiments, an alternate path may be used for media where client stations exchange traffic directly with the ITSP. The Configuration Server 214 serves configuration files to the client stations over TFTP.

When a user places a telephone call from a telephone 112 in the PSTN 110 to a DID number associated with one of the stations serviced by the ITSP 120, the ITSP 120 will terminate the telephone call and utilize a signaling protocol, such as, e.g., SIP, to signal the station in order to establish a multimedia session between the PSTN gateway 122 and the station.

Under the conventional SIP protocol, the ITSP 120 will transmit a SIP INVITE request message to the SIP server associated with that DID number. SIP requests have a Request-Line for a start-line. The Request-Line contains a method name (e.g., INVITE), a Request-URI (Uniform Resource Identifier), and the SIP protocol version. SIP uses Uniform Resource Locators (URLs) to identify the source, current destination, ultimate destination, and to specify redirection (forwarding) addresses. Therefore, the Request-URI will comprise a SIP URL which corresponds to the user or service to which this request is being addressed.

The header is a component of a SIP message that conveys information about the message. The header comprises a sequence of one or more header field rows. A header field row comprises a header field name and zero or more header field values. A valid SIP request contains at least the following additional header fields: TO, FROM, CSEQ, CALL-ID, MAX-FORWARDS, and VIA. Typically, the TO field contains a display name and a SIP URL set to the value of the URI in the Request-URI.

In particular embodiments, the IP PBX registers a single address with the ITSP per line interface (e.g., one address per SIP trunk). The ITSP will use the binding from this registration for a group of DID numbers allocated to this SIP trunk. The ITSP will embed the DID information in SIP messages when routing calls to the single address over the SIP trunk. The IP PBX then extracts the DID information from the SIP messages and rings the corresponding target phone (without going through a live or automated attendant). Therefore, the calling party user agent (e.g., the ITSP PSTN gateway 122) will direct all SIP INVITE requests corresponding to one of the group of DID numbers to a single Request-URI associated with the IP PBX 160. The identity of the target client station (e.g., the DID number dialed by the calling party) is provided in a separate header field within the SIP INVITE request. The IP PBX then extracts the identity of the target client station from the INVITE request, and forwards the INVITE request to the SIP URL associated with the target client station.

In the example shown in FIG. 1, a customer at the customer location 150 may sign up for VoIP services from the ITSP 120. As part of the VoIP services, the ITSP 120 may allocate a set of DID numbers to be associated with a single account. This single account may be associated with, e.g., a single line interface 201 of the IP PBX 160.

This set of DID numbers may be, e.g., a block of ten sequential telephone numbers 408-555-3000 through 408-555-3009. All of these DID numbers are then associated with a single primary SIP URL such that the PSTN gateway 122 transmits SIP INVITE requests to that primary SIP URL for all telephone calls directed to any of the DID numbers in the set.

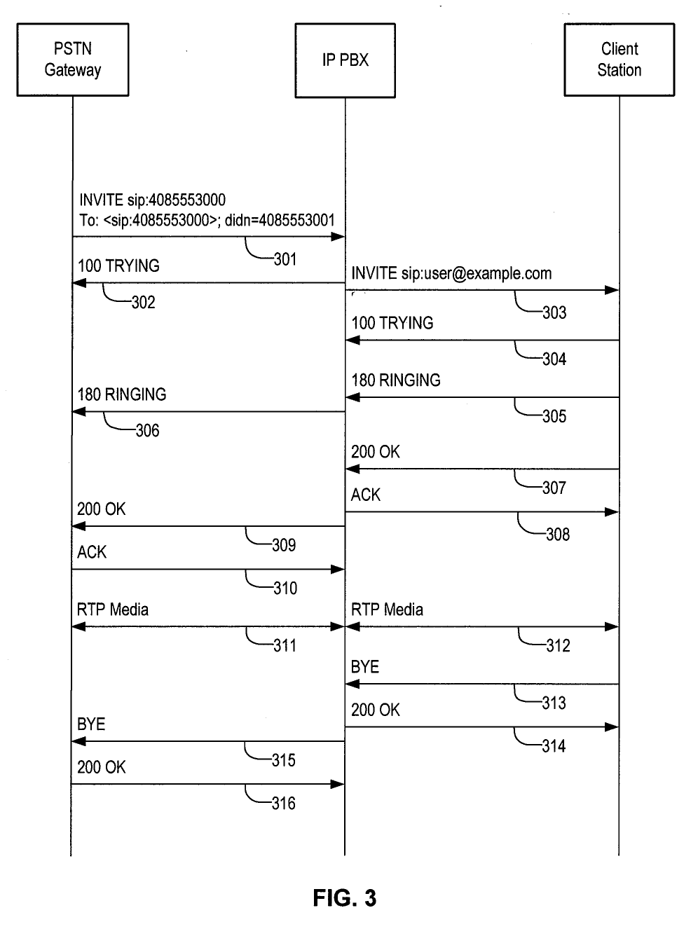

FIG. 3 illustrates an example call flow, in particular embodiments. As described above, when a user places a telephone call from a telephone 112 in the PSTN 110 to one of the DID numbers in the set (e.g., 408-555-3001), the PSTN gateway 122 will terminate the telephone call. In step 301, the PSTN gateway 122 will transmit a SIP INVITE request to the primary SIP URL. This INVITE request may be formatted as follows:
INVITE sip:4085553000@itsp1.com SIP/2.0
To: <sip:4085553001@itsp1.com>

The Request-URI may be addressed to an account associated with the line interface that is logically connected to the corresponding ITSP which sends the call to the IP PBX. In this case, the primary SIP URL used for the Request-URI in the INVITE request is the SIP URL associated with the first telephone number in the set of DID numbers, 4085553000@itsp1.com. In various embodiments, an ITSP account is associated with a single User ID, and this User ID may be used as the value provided as the Request-URI. For example, the User ID used as the Request-URI may be the first telephone number in the set of DID numbers, as in the example above. Alternatively, the User ID may be an alphanumeric string, such as “user1”. In this case, the INVITE request may be formatted as follows:
INVITE sip: user1@itsp1.com SIP/2.0
To: <sip:4085553001@itsp1.com>

The TO header following the Request-Line of the INVITE request may be used to provide the IP PBX with the identity of the target client station. According to the SIP protocol, the interpretation of the characters contained in the TO header is left to the discretion of the user agent. Therefore, the precise format with which the dialed DID number is provided may vary, and the use of a TO header which does not match the Request-URI is unconventional, but not in conflict with the SIP protocol.

In other embodiments, the TO header may first identify the same SIP URL provided in the Request-URI, and the dialed DID number may be indicated elsewhere in the TO header, as follows:
INVITE sip:4085553000@itsp1.com SIP/2.0
To: <sip:4085553000@itsp1.com>;didn=4085553001

In this example, the DID number is indicated by the parameter name “didn”. The IP PBX 160 may be configured to extract the number following the “didn” parameter name. The IP PBX 160 includes a memory which stores the appropriate SIP URLs that correspond to each of the DID number associated with the location's account. Thus, after retrieving the DID number from the INVITE request, the IP PBX 160 may then extract the SIP URL that corresponds to that DID number and forward the SIP INVITE request to that SIP URL, as shown in step 303. In step 303, the INVITE request is modified by the IP PBX 160 so that the Request-URI identifies the SIP URL for the target client station. The IP PBX 160 will also transmit a 100 TRYING message back to the originating user agent (e.g., the PSTN gateway), in step 302.

In step 304, the IP PBX 160 will transmit a 100 TRYING response back to the originating user agent. In step 305, the target client station will transmit a 180 RINGING response to the IP PBX 160, which, in turn, will forward the 180 RINGING response to the gateway 122 in step 306.

After the call is connected (e.g., the user picks up the handset on the client station 170a), the client station in step 307 will transmit a 200 OK response to the IP PBX 160. In step 308, the IP PBX 160 will transmit an ACK message back to the client station, and then in step 309 will forward the 200 OK response to the PSTN gateway 122. The PSTN gateway 122 in step 310 will transmit an ACK request back to the IP PBX to acknowledge reception of a final response to the original INVITE request. In steps 311-312, the gateway 122 and the client station will begin a media session. In some embodiments, the IP PBX 160 may function as a media proxy between the gateway and the client station. In other embodiments, the gateway and the client station may communicate directly.

Finally, when the called party hangs up the phone to terminate the call, the client station in step 313 will transmit a BYE request to abandon the session. In step 314, the IP PBX will transmit a 200 OK response to the client station, and in step 315 will transmit a BYE request to the PSTN gateway. In step 316, the PSTN gateway will transmit a 200 OK response to confirm the end of the session.

Particular embodiments may provide various advantages not provided by prior art systems. As described above, the ITSP 120 directs all calls to any of the set of DID numbers to a single primary SIP URL. Thus, it is not necessary for a subscriber to register each individual DID number with the ITSP 120 and to provide the ITSP 120 with configuration information for each client station. The ITSP 120 may only be provided with sufficient information to route the calls to a single line interface. The IP PBX 160 receiving the INVITE requests transmitted to the primary SIP URL associated with that line interface will then manage the location and signaling with the target client stations. This can decrease the administrative burden placed on the IP telephony administrator at the customer location 150. In addition, the ITSP need only maintain a single account to service the customer location 150, with a single User ID and password, rather than having to manage an account, User ID, and password for each DID number.

While the invention has been described in terms of particular embodiments and illustrative figures, those of ordinary skill in the art will recognize that the invention is not limited to the embodiments or figures described. For example, in many of the embodiments described above, the identity of the target client station (e.g., the DID number dialed by the caller) is provided in the TO field of the INVITE request. In other embodiments, the identity of the target client station may be contained elsewhere in the INVITE request, such as in one of the other headers defined by the SIP specification, or in a new header defined by the IP PBX manufacturer.

In addition, in embodiments described above, the IP PBX retrieves the DID number from the SIP INVITE request transmitted by the ITSP and then routes the call to a single target station associated with that DID number. In other embodiments, the call may be routed differently. The DID number need not have a one-to-one mapping with a target client station. For example, in some embodiments, each client station may be assigned one or more virtual extensions. The IP PBX may be configured to route calls directed to a certain DID number to a plurality of virtual extensions either sequentially or simultaneously. An administrator of the IP PBX may be able to define configurable rules for how calls to each DID number are to be routed (e.g., first ring extension 1001; if no answer after three rings, then ring extension 1002; if no answer after three rings, then ring extension 1003; if no answer after three rings, send to voicemail). In each case, the IP PBX will first retrieve the target DID number from the SIP INVITE in order to determine how to route the call.

The program logic described indicates certain events occurring in a certain order. Those of ordinary skill in the art will recognize that the ordering of certain programming steps or program flow may be modified without affecting the overall operation performed by the preferred embodiment logic, and such modifications are in accordance with the various embodiments of the invention. Additionally, certain of the steps may be performed concurrently in a parallel process when possible, as well as performed sequentially as described above.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. A method, comprising:
at an IP private branch exchange (IP PBX), receiving a SIP INVITE request comprising a Request-URI field identifying a Uniform Resource Identifier (URI) of the IP PBX and a header field identifying a target direct inward dial (DID) number;
identifying a URI corresponding to the target DID number; and
forwarding the SIP INVITE request with a Request-URI field identifying the URI corresponding to the target DID number.

2. The method of claim 1, wherein the header field identifying the target DID number comprises a TO field of the INVITE request.

3. The method of claim 2, wherein the TO field comprises a SIP URL and a DID parameter, wherein said DID parameter identifies the target DID number.

4. The method of claim 1, wherein the IP PBX is provided in a local area network (LAN) containing the target DID number.

5. The method of claim 1, further comprising, in response to receiving the SIP INVITE request at the IP PBX, retrieving a network location of the target DID number.

6. The method of claim 5, wherein said retrieving the network location of the target DID number comprises retrieving the network location from a database stored in the IP PBX.

7. The method of claim 5, wherein said retrieving the network location of the target DID number comprises retrieving an IP address of the target DID number.

8. The method of claim 5, wherein said retrieving the network location of the target DID number comprises retrieving a SIP URL of the target DID number.

9. A system, comprising:
an IP PBX configured to:
receive a SIP INVITE request comprising a Request-URI field identifying a Uniform Resource Identifier (URI) of the IP PBX and a header field identifying a target DID number;
identify a URI corresponding to the target DID number; and
forward the SIP INVITE request with a Request-URI field identifying the URI corresponding to the target DID number.

10. The system of claim 9, wherein the header field identifying the target DID number comprises a TO field of the INVITE request.

11. The system of claim 10, wherein the TO field comprises a SIP URL and a DID parameter, wherein said DID parameter identifies the target DID number.

12. The system of claim 9, further comprising a local area network (LAN), said LAN containing the IP PBX and the target DID number.

13. The system of claim 9, wherein the IP PBX is configured to retrieve a network location of the target DID number in response to receiving the SIP INVITE request at the IP PBX.

14. The system of claim 13, wherein the IP PBX comprises a database storing a plurality of target DID number identities and a plurality of network locations, each network location being associated with one of the plurality of target DID numbers.

15. The system of claim 13, wherein the IP PBX is configured to retrieve the network location of the target DID number by retrieving an IP address of the target DID number.

16. The system of claim 13, wherein the IP PBX is configured to retrieve the network location of the target DID number by retrieving a SIP URL of the target DID number.

17. The system of claim 9, further comprising a public switched telephone network (PSTN) gateway configured to terminate telephone calls from a PSTN and to generate the SIP INVITE request comprising the Request-URI field identifying the URI of the IP PBX and the header field identifying the target DID number.

18. A system, comprising:
a public switched telephone network (PSTN) gateway configured to:
terminate a telephone call from a PSTN directed to a target DID number associated with an IP PBX; and
generate a SIP INVITE request comprising a Request-URI field identifying a Uniform Resource Identifier (URI) of the IP PBX and a header field identifying the target DID number.

19. The system of claim 18, wherein the header field identifying the target DID number comprises a TO field of the INVITE request.

20. The system of claim 18, wherein the TO field comprises a SIP URL and a DID parameter, wherein said DID parameter identifies the target DID number.
